(19) United States
(12) Patent Application Publication
(10) Pub. No.: US 2012/0110094 A1
(43) Pub. Date: May 3, 2012

(54) ELECTRONIC MESSAGING SYSTEMS SUPPORTING PROVISION OF ENTIRE FORWARDING HISTORY REGARDING THE SENDING, RECEIVING, AND TIME ZONE INFORMATION, OF AN EMAIL AFTER THE EMAIL IS FORWARDED BY A NUMBER OF USERS

(76) Inventor: Yat Wai Edwin Kwong, (US)

(21) Appl. No.: 12/938,750

(22) Filed: Nov. 3, 2010

(51) Int. Cl. G06F 15/16

(52) U.S. Cl. 709/206

(57) ABSTRACT

Systems and methods are provided for supporting provision of forwarding history of email information. In accordance with one implementation, a system is provided that includes supporting provisioning of entire forwarding history regarding the sending and receiving time zone information, of an email after the email has been forwarded by a number of users. The system is further configured to send, by the email sender, an email to the email receiver, through a email incoming server. Further, the system allows users to compose outgoing emails to another email receiver. In addition, the system includes sending the outgoing email, by the email receiver, to the other email receiver through a SMTP server.

### BACKGROUND

I. Technical Field

The present invention generally relates to the field of supporting provision of forwarding history of email information. Specifically, and without limitation, the invention relates to systems and methods that support provisioning of entire forwarding history regarding the sending and receiving time zone information, of an email after the email has been forwarded by a number of users.

II. Background Information

Email users receive forwarded emails on a daily basis. Sometimes, when an email is received by a particular user, the email has been forwarded to other users for a few times. In some cases, the particular user may be interested to know who is the original user drafting the email. Further, the particular user may be interested to know when the original email was drafted. However, the particular user may not be able to find out such information with high accuracy, due to time zone differences between the location where the original email was drafted and the location where the particular user received the email. To illustrate the point at question with an example, assuming that the original email was drafted in New York and ultimately read by a California email reader, after a series of forwarding activities by unknown users in the middle of the process. When the California reader reads the email, he or she may misread the time information stated in the original email, due to the time zone differences between the two cities. This problem is attributed to current flaw of email design architecture. Specifically, when an email is sent, the time sent or received, together with the time-zone information, is included in the header of the email. However, after the email has been forwarded by other users after a number of time, the time-zone information where the original email was sent may likely be lost, as forwarded emails usually discard specific time-zone information of the forwarded emails. Quite often, when a particular email user reads the forwarded email, what is indicated is only, at best, the local time when the original email was sent or received by the first recipient. The valuable time-zone information would have been lost in the forwarding process. As such, the ultimate particular user would not be able to sort out the exact time when the original email was sent or received by the first recipient.

In view of the foregoing, there is a need for systems and methods that supporting provision of forwarding history of email information. There is also a need for systems and methods that can support provisioning of entire forwarding history regarding the sending and receiving time zone information, of an email after the email has been forwarded by a number of users.

### SUMMARY

Embodiments of the present invention relate to systems and methods for supporting provision of forwarding history of email information. Certain embodiments of the invention include connecting to a mobile device connecting to an email sender, a mobile device connecting to an email receiver, and a mobile device connecting to another email receiver. Such mobile devices may include cell phones, PDAs, or other portable devices. Consistent with the above-stated embodiments, a process and a memory may also be included. The memory stores instructions to cause the processor to perform a method. The method may comprise sending, by the email sender, an email, as a first email, to the email receiver, through a email incoming server. Further, the method may comprise composing an outgoing email, as a second email, by the email receiver to forward the outgoing email to another email receiver. Even further, the method may comprise sending the outgoing email, by the email receiver, to the another email receiver through a SMTP server.

In accordance with an embodiment of the present invention, the first email may include a series of forwarded emails previously sent from other users, and the email may include complete time zone information of each of the forwarded emails. More, the email may include information with respect to incoming time of receiving the email from the incoming server, the incoming time and the complete time zone information of each of the forwarded emails represented in UTC format. Alternatively, the email may include information with respect to sending time when the email is sent from the email sender, the sending time and the complete time zone information of each of the forwarded emails represented in UTC format.

In the embodiment, the outgoing email may include a series of the forwarded emails previously sent from the other users. The outgoing email may also include only the complete time zone information of each of the forwarded emails without including the time zone information where the outgoing email is sent. After the outgoing email is sent, the SMTP server may be adapted to detect that the outgoing email fails to include the time zone information where the outgoing email is sent and that the complete time zone information of each of the forwarded emails are represented in UTC format. The SMTP server, in such a case, may reject the outgoing email, and return the outgoing email back to the email receiver to wait for a resent of the outgoing email by the email receiver.

In another embodiment, the SMTP server may convert the incoming time and the complete time zone information of each of the forwarded emails from the UTC format to a non-UTC format, in accordance with time zone of the incoming server. In the process, the SMTP server may include some information into the outgoing email. Such information includes both the incoming time and the complete time zone information of each of the forwarded emails in the non-UTC format, wherein the incoming time and the complete time zone information are included in the outgoing email as email body before the outgoing email is sent. Additionally, the SMTP server 160 may also includes other information in the outgoing email. The other information includes the outgoing time in the outgoing email when the outgoing email is sent, wherein the outgoing time is represented in UTC format and included in an email header of the outgoing email. The outgoing email may be passed through a MTP server, and then received by another email receiver. The outgoing email received by the another email receiver may include information such as the complete time zone information of each of the forwarded emails and the time zone information of the outgoing time when the outgoing email is sent.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating an exemplary system, consistent with an embodiment of the present invention.

### DETAILED DESCRIPTION

Embodiments of the present invention relate to systems and methods for supporting provision of forwarding history of email information. Certain embodiments of the invention include a memory and a processor. The processor may be adapted to execute executable instructions using the processor. The instructions include, for example, receiving, by an email client serving as part of the electronic messaging system, an incoming email from an email incoming server; and composing an outgoing email after receiving the incoming email.

Reference will now be made in detail to the present exemplary embodiments of the invention, examples of which are illustrated in the accompanying drawings. Wherever possible, the same reference numbers will be used throughout the drawings to refer to the same or like parts.

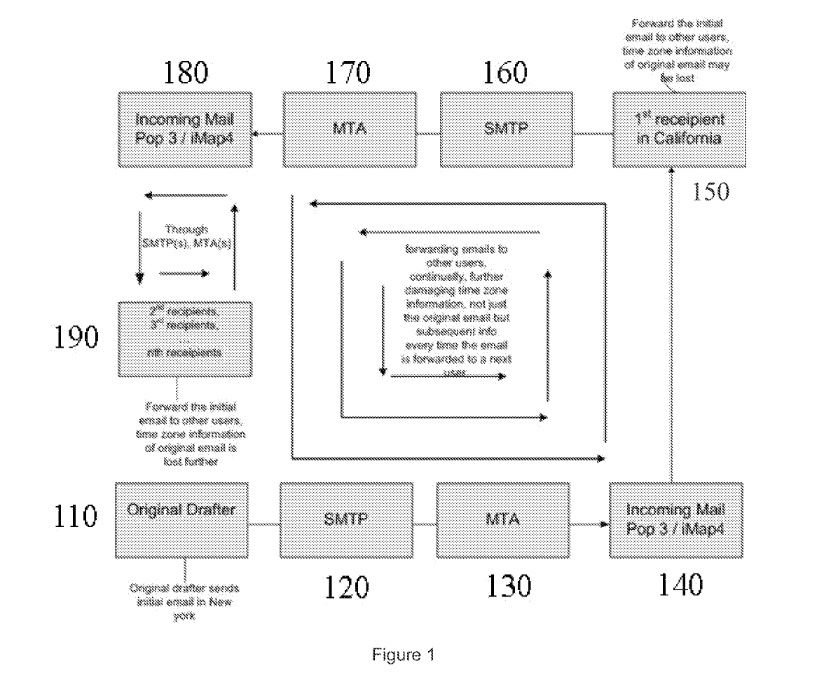

Referring to FIG. 1, an email client serving as part of the electronic messaging system may receive an incoming email from a mail incoming server 140. The email may include information with respect to sending time when the email is sent from a sender 110. The sending time may be represented multiple formats. One format includes the UTC format.

A user, after received the email from the sender, may compose outgoing emails. The outgoing emails may include the incoming emails serving as forwarded emails.

When the user completes drafting his or her email, the email client 150 may include both the sending time in the UTC format and information concerning the time zone of the sender into the outgoing email. The sending time may be included in the outgoing email as an email body or an email header, before the outgoing email is sent.

The email client 150 may also include the outgoing time in the outgoing email when the outgoing email is sent. The outgoing time may be represented in UTC format and included in the email header or in the email body of the outgoing email.

In a different embodiment, the email client 150 may be adapted to convert the incoming time from the UTC format to a non-UTC format, in accordance with time zone of the incoming server. The email client 150 may then include both the incoming time in the non-UTC format and information concerning time zone of the incoming server, wherein the incoming time is also included in the outgoing email as an email header or an email body, before the outgoing email is sent.

In yet another embodiment, the email received by the email client 150 may include information with respect to sending time when the email is sent from the sender. In which case, the sending time may be represented in UTC format.

Alternatively, the email client 150 may selectively include information before the outgoing email is sent. For example, the email client 150 may only include the sending time in the non-UTC format without including information concerning the time zone of the incoming server into the outgoing email.

The present invention may be implemented as a computer-implemented method. In which case, the method may comprise sending, by the email sender, an email, as a first email, to the email receiver, through an email incoming server, wherein the email includes a series of forwarded emails previously sent from other users, and the email includes complete time zone information of each of the forwarded emails, and the email includes information with respect to incoming time of receiving the email from the incoming server, the incoming time and the complete time zone information of each of the forwarded emails represented in UTC format. The method may compose an outgoing email, as a second email, by the email receiver to forward the outgoing email to the another email receiver, wherein the outgoing email includes the series of the forwarded emails previously sent from the other users. Further, the method includes sending the outgoing email, by the email receiver, to the another email receiver through a SMTP server 160, wherein the outgoing email includes only the complete time zone information of each of the forwarded emails without including the time zone information where the outgoing email is sent. Further, the method includes detecting, by the SMTP 160 server that receives outgoing emails from the email receiver, that the outgoing email fails to include the time zone information where the outgoing email is sent. Even further, the method comprises including into the outgoing email, by the SMTP server 160, the time zone information where the outgoing email is sent and is represented in UTC format, wherein the incoming time is included in the outgoing email as email body before the outgoing email is sent; and including into the outgoing email, by the SMTP server 160, the time zone information of the outgoing time when the outgoing email is sent, wherein the outgoing time is represented in UTC format and included in an email header of the outgoing email. After going through a MTA server 170, the outgoing email may be received by the another email receiver, wherein the outgoing email received by the another email receiver includes the complete time zone information of each of the forwarded emails and the time zone information of the outgoing time when the outgoing email is sent.

In accordance with an alternate embodiment of the invention, the method may comprise sending, by the email sender, an email, as a first email, to the email receiver, through an email incoming server, wherein the email includes a series of forwarded emails previously sent from other users, and the email includes complete time zone information of each of the forwarded emails, and the email includes information with respect to incoming time of receiving the email from the incoming server, the incoming time and the complete time zone information of each of the forwarded emails represented in UTC format.

The method further comprises other steps, which include composing an outgoing email, as a second email, by the email receiver to forward the outgoing email to the another email receiver, wherein the outgoing email includes the series of the forwarded emails previously sent from the other users; sending the outgoing email, by the email receiver, to the another email receiver through a SMTP server 160, wherein the outgoing email includes only the complete time zone information of each of the forwarded emails without including the time zone information where the outgoing email is sent; detecting, by the SMTP server 160 that receives outgoing emails from the email receiver, that the outgoing email fails to include the time zone information where the outgoing email is sent and that the complete time zone information of each of the forwarded emails are represented in UTC format; converting, by the SMTP server 160 that receives outgoing emails from the email receiver, the incoming time and the complete time zone information of each of the forwarded emails from the UTC format to a non-UTC format, in accordance with time zone of the incoming server; including into the outgoing email, by the SMTP server 160, both the incoming time and the complete time zone information of each of the forwarded emails in the non-UTC format, wherein the incoming time and the complete time zone information are included in the outgoing email as email body before the outgoing email is sent; including into the outgoing email, by the SMTP server 160, the outgoing time in the outgoing email when the outgoing email is sent, wherein the outgoing time is represented in UTC format and included in an email header of the outgoing email; and receiving, after going through a MTA server 170, the outgoing email by the another email receiver, wherein the outgoing email received by the another email receiver includes the complete time zone information of each of the forwarded emails and the time zone information of the outgoing time when the outgoing email is sent.

The method may be implemented in a number of ways. As an example, the method may include sending, by the email sender, an email, as a first email, to the email receiver, through an email incoming server, wherein the email includes a series of forwarded emails previously sent from other users, and the email includes complete time zone information of each of the forwarded emails, and the email includes information with respect to sending time when the email is sent from the email sender, the sending time and the complete time zone information of each of the forwarded emails represented in UTC format; composing an outgoing email, as a second email, by the email receiver to forward the outgoing email to the another email receiver, wherein the outgoing email includes the series of the forwarded emails previously sent from the other users; sending the outgoing email, by the email receiver, to the another email receiver through a SMTP server 160, wherein the outgoing email includes only the complete time zone information of each of the forwarded emails without including the time zone information where the outgoing email is sent; detecting, by the SMTP server 160 that receives outgoing emails from the email receiver, that the outgoing email fails to include the time zone information where the outgoing email is sent and that the complete time zone information of each of the forwarded emails are represented in UTC format; converting, by the SMTP server 160 that receives outgoing emails from the email receiver, the sending time and the complete time zone information of each of the forwarded emails from the UTC format to a non-UTC format, in accordance with time zone of the incoming server; including into the outgoing email, by the SMTP server 160, both the incoming time and the complete time zone information of each of the forwarded emails in the non-UTC format, wherein the incoming time and the complete time zone information are included in the outgoing email as email body before the outgoing email is sent; including into the outgoing email, by the SMTP server 160, the outgoing time in the outgoing email when the outgoing email is sent, wherein the outgoing time is represented in UTC format and included in an email header of the outgoing email; and receiving, after going through a MTA server 170, the outgoing email by the another email receiver, wherein the outgoing email received by the another email receiver includes the complete time zone information of each of the forwarded emails and the time zone information of the outgoing time when the outgoing email is sent.

In another implementation, the method may comprise sending, by the email sender, an email, as a first email, to the email receiver, through an email incoming server, wherein the email includes a series of forwarded emails previously sent from other users, and the email includes complete time zone information of each of the forwarded emails, and the email includes information with respect to sending time when the email is sent from a sender, the sending time and the complete time zone information of each of the forwarded emails represented in UTC format; composing an outgoing email, as a second email, by the email receiver to forward the outgoing email to the another email receiver, wherein the outgoing email includes the series of the forwarded emails previously sent from the other users; sending the outgoing email, by the email receiver, to the another email receiver through a SMTP server 160, wherein the outgoing email includes only the complete time zone information of each of the forwarded emails without including the time zone information where the outgoing email is sent; detecting, by the SMTP server 160 that receives outgoing emails from the email receiver, that the outgoing email fails to include the time zone information where the outgoing email is sent and that the complete time zone information of each of the forwarded emails are represented in UTC format; converting, by the SMTP server 160 that receives outgoing emails from the email receiver, the sending time and the complete time zone information of each of the forwarded emails from the UTC format to a non-UTC format, in accordance with time zone of the incoming server; including into the outgoing email, by the SMTP server 160, both the sending time and the complete time zone information of each of the forwarded emails in the non-UTC format, wherein the sending time and the complete time zone information are included in the outgoing email as email body before the outgoing email is sent; including into the outgoing email, by the SMTP server 160, the outgoing time in the outgoing email when the outgoing email is sent, wherein the outgoing time is represented in UTC format and included in an email header of the outgoing email; and receiving, after going through a MTA server 170, the outgoing email by the another email receiver, wherein the outgoing email received by the another email receiver includes the complete time zone information of each of the forwarded emails and the time zone information of the outgoing time when the outgoing email is sent.

The method may be further implemented with other features. For example, the method may comprise sending, by the email sender, an email, as a first email, to the email receiver, through an email incoming server, wherein the email includes a series of forwarded emails previously sent from other users, and the email includes complete time zone information of each of the forwarded emails, and the email includes information with respect to incoming time of receiving the email from the incoming server, the incoming time and the complete time zone information of each of the forwarded emails represented in UTC format; composing an outgoing email, as a second email, by the email receiver to forward the outgoing email to the another email receiver, wherein the outgoing email includes the series of the forwarded emails previously sent from the other users; sending the outgoing email, by the email receiver, to the another email receiver through a SMTP server 160, wherein the outgoing email includes only the complete time zone information of each of the forwarded emails without including the time zone information where the outgoing email is sent; detecting, by the SMTP server 160 that receives outgoing emails from the email receiver, that the outgoing email fails to include the time zone information where the outgoing email is sent and that the complete time zone information of each of the forwarded emails are represented in UTC format; rejecting, by the SMTP server 160, the outgoing email, after the detection by the SMTP server 160; returning, by the SMTP server 160, the outgoing email back to the email receiver; converting, by the email receiver, the incoming time and the complete time zone information of each of the forwarded emails from the UTC format to a non-UTC format, in accordance with time zone of the incoming server; including into the outgoing email, by the email receiver, both the incoming time and the complete time zone information of each of the forwarded emails in the non-UTC format, wherein the incoming time and the complete time zone information are included in the outgoing email as email body before the outgoing email is sent; including into the outgoing email, by the email receiver, the outgoing time in the outgoing email when the outgoing email is sent, wherein the outgoing time is represented in UTC format and included in an email header of the outgoing email; resending the outgoing email by the email receiver to the SMTP server 160; and receiving, after going through the SMTP server and a MTA server 170, the outgoing email by the another email receiver, wherein the outgoing email received by the another email receiver includes the complete time zone information of each of the forwarded emails and the time zone information of the outgoing time when the outgoing email is sent.

Method steps according to embodiments of the invention can be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

What is claimed is:

1. An electronic messaging system comprising:
a mobile device connecting to an email sender;
a mobile device connecting to an email receiver;
a mobile device connecting to another email receiver;
a processor; and
a memory storing instructions to cause the processor to perform a method, comprising
sending, by the email sender, an email, as a first email, to the email receiver, through a email incoming server;
composing an outgoing email, as a second email, by the email receiver to forward the outgoing email to the another email receiver; and
sending the outgoing email, by the email receiver, to the another email receiver through a SMTP server.

2. The system of claim 1, wherein
the email includes a series of forwarded emails previously sent from other users, and the email includes complete time zone information of each of the forwarded emails, and the email includes information with respect to incoming time of receiving the email from the incoming server, the incoming time and the complete time zone information of each of the forwarded emails represented in UTC format;
the outgoing email includes the series of the forwarded emails previously sent from the other users;
the outgoing email includes only the complete time zone information of each of the forwarded emails without including the time zone information where the outgoing email is sent; and
the method further comprises:
detecting, by the SMTP server that receives outgoing emails from the email receiver, that the outgoing email fails to include the time zone information where the outgoing email is sent and that the complete time zone information of each of the forwarded emails are represented in UTC format;
converting, by the SMTP server that receives outgoing emails from the email receiver, the incoming time and the complete time zone information of each of the forwarded emails from the UTC format to a non-UTC format, in accordance with time zone of the incoming server;
including into the outgoing email, by the SMTP server, both the incoming time and the complete time zone information of each of the forwarded emails in the non-UTC format, wherein the incoming time and the complete time zone information are included in the outgoing email as email body before the outgoing email is sent;
including into the outgoing email, by the SMTP server, the outgoing time in the outgoing email when the outgoing email is sent, wherein the outgoing time is represented in UTC format and included in an email header of the outgoing email; and
receiving, after going through a MTP server, the outgoing email by the another email receiver, wherein the outgoing email received by the another email receiver includes the complete time zone information of each of the forwarded emails and the time zone information of the outgoing time when the outgoing email is sent.

3. The system of claim 1, wherein
the email includes a series of forwarded emails previously sent from other users, and the email includes complete time zone information of each of the forwarded emails, and the email includes information with respect to sending time when the email is sent from the email sender, the sending time and the complete time zone information of each of the forwarded emails represented in UTC format;
the outgoing email includes the series of the forwarded emails previously sent from the other users;
the outgoing email includes only the complete time zone information of each of the forwarded emails without including the time zone information where the outgoing email is sent; and
the method further comprises:
detecting, by the SMTP server that receives outgoing emails from the email receiver, that the outgoing email fails to include the time zone information where the outgoing email is sent and that the complete time zone information of each of the forwarded emails are represented in UTC format;
converting, by the SMTP server that receives outgoing emails from the email receiver, the sending time and the complete time zone information of each of the forwarded emails from the UTC format to a non-UTC format, in accordance with time zone of the incoming server;
including into the outgoing email, by the SMTP server, both the incoming time and the complete time zone information of each of the forwarded emails in the non-UTC format, wherein the incoming time and the complete time zone information are included in the outgoing email as email body before the outgoing email is sent;
including into the outgoing email, by the SMTP server, the outgoing time in the outgoing email when the outgoing email is sent, wherein the outgoing time is represented in UTC format and included in an email header of the outgoing email; and
receiving, after going through a MTP server, the outgoing email by the another email receiver, wherein the outgoing email received by the another email receiver includes the complete time zone information of each of the forwarded emails and the time zone information of the outgoing time when the outgoing email is sent.

4. The system of claim 1, wherein:
the email includes a series of forwarded emails previously sent from other users, and the email includes complete time zone information of each of the forwarded emails, and the email includes information with respect to sending time when the email is sent from a sender, the sending time and the complete time zone information of each of the forwarded emails represented in UTC format;
the outgoing email includes the series of the forwarded emails previously sent from the other users;
the outgoing email includes only the complete time zone information of each of the forwarded emails without including the time zone information where the outgoing email is sent; and
the method further comprises:
detecting, by the SMTP server that receives outgoing emails from the email receiver, that the outgoing email fails to include the time zone information where the outgoing email is sent and that the complete time zone information of each of the forwarded emails are represented in UTC format;
converting, by the SMTP server that receives outgoing emails from the email receiver, the sending time and the complete time zone information of each of the forwarded emails from the UTC format to a non-UTC format, in accordance with time zone of the incoming server;
including into the outgoing email, by the SMTP server, both the sending time and the complete time zone information of each of the forwarded emails in the non-UTC format, wherein the sending time and the complete time zone information are included in the outgoing email as email body before the outgoing email is sent;
including into the outgoing email, by the SMTP server, the outgoing time in the outgoing email when the outgoing email is sent, wherein the outgoing time is represented in UTC format and included in an email header of the outgoing email; and
receiving, after going through a MTP server, the outgoing email by the another email receiver, wherein the outgoing email received by the another email receiver includes the complete time zone information of each of the forwarded emails and the time zone information of the outgoing time when the outgoing email is sent.

5. The system of claim 1, wherein
the email includes a series of forwarded emails previously sent from other users, and the email includes complete time zone information of each of the forwarded emails, and the email includes information with respect to incoming time of receiving the email from the incoming server, the incoming time and the complete time zone information of each of the forwarded emails represented in UTC format;
the outgoing email includes the series of the forwarded emails previously sent from the other users;
the outgoing email includes only the complete time zone information of each of the forwarded emails without including the time zone information where the outgoing email is sent; and
the method further comprises:
detecting, by the SMTP server that receives outgoing emails from the email receiver, that the outgoing email fails to include the time zone information where the outgoing email is sent and that the complete time zone information of each of the forwarded emails are represented in UTC format;
rejecting, by the SMTP server, the outgoing email, after the detection by the SMTP server;
returning, by the SMTP server, the outgoing email back to the email receiver;
converting, by the email receiver, the incoming time and the complete time zone information of each of the forwarded emails from the UTC format to a non-UTC format, in accordance with time zone of the incoming server;
including into the outgoing email, by the email receiver, both the incoming time and the complete time zone information of each of the forwarded emails in the non-UTC format, wherein the incoming time and the complete time zone information are included in the outgoing email as email body before the outgoing email is sent;
including into the outgoing email, by the email receiver, the outgoing time in the outgoing email when the outgoing email is sent, wherein the outgoing time is represented in UTC format and included in an email header of the outgoing email;
resending the outgoing email by the email receiver to the SMTP server; and
receiving, after going through the SMTP server and a MTP server, the outgoing email by the another email receiver, wherein the outgoing email received by the another email receiver includes the complete time zone information of each of the forwarded emails and the time zone information of the outgoing time when the outgoing email is sent.

6. An electronic messaging system comprising:
a processor; and
a memory storing instructions to cause the processor to perform a method, comprising
receiving, by an email client serving as part of the electronic messaging system, an incoming email from an email incoming server; and
composing an outgoing email after receiving the incoming email.

7. The system of claim 6, wherein
the email includes information with respect to incoming time of receiving the email from the incoming server, the incoming time represented in UTC format;
the outgoing email includes the incoming email serving as a forwarded email; and
the method further comprises:
including, by the email client, the incoming time represented in UTC format in the outgoing email, wherein the incoming time is included in the outgoing email as email header before the outgoing email is sent; and
including, by the email client, outgoing time when the outgoing email is sent, wherein the outgoing time is represented in UTC format and included in an email header of the outgoing email.

8. The system of claim 6, wherein
the email includes information with respect to incoming time of receiving the email from the incoming server, the incoming time represented in UTC format;
the outgoing email includes the incoming email serving as a forwarded email; and
the method further comprises:
converting, by the email client, the incoming time from the UTC format to a non-UTC format, in accordance with time zone of the incoming server;
including, by the email client, both the incoming time in the non-UTC format and information concerning time zone of the incoming server, wherein the incoming time is included in the outgoing email as email header before the outgoing email is sent; and
including, by the email client, the outgoing time in the outgoing email when the outgoing email is sent, wherein the outgoing time is represented in UTC format and included in an email header of the outgoing email.

9. The system of claim 6, wherein
the email includes information with respect to sending time when the email is sent from a sender, the sending time represented in UTC format;
the outgoing email includes the incoming email serving as a forwarded email; and
the method further comprises:
converting, by the email client, the sending time from the UTC format to a non-UTC format, in accordance with time zone of the sender;
including, by the email client, both the sending time in the non-UTC format and information concerning the time zone of the sender into the outgoing email, wherein the sending time is included in the outgoing email as email header before the outgoing email is sent; and
including, by the email client, the outgoing time in the outgoing email when the outgoing email is sent, wherein the outgoing time is represented in UTC format and included in an email header of the outgoing email;

10. The system of claim 6, wherein
the email includes information with respect to sending time when the email is sent from a sender, the sending time represented in UTC format;
the outgoing email includes the incoming email serving as a forwarded email; and
the method further comprises:
converting, by the email client, the sending time from the UTC format to a non-UTC format, in accordance with time zone of the incoming server;
including, by the email client, both the sending time in the non-UTC format and information concerning the time zone of the incoming server into the outgoing email, wherein the sending time is included in the outgoing email as email header before the outgoing email is sent; and
including, by the email client, the outgoing time in the outgoing email when the outgoing email is sent, wherein the outgoing time is represented in UTC format and included in an email header of the outgoing email.

11. The system of claim 6, wherein
the email includes information with respect to sending time when the email is sent from a sender, the sending time represented in UTC format; and
the method further comprises:
composing an outgoing email after receiving the incoming email, wherein the outgoing email includes the incoming email serving as a forwarded email;
converting, by the email client, the sending time from the UTC format to a non-UTC format, in accordance with time zone of the incoming server;
including, by the email client, only the sending time in the non-UTC format without including information concerning the time zone of the incoming server into the outgoing email, wherein the sending time is included in the outgoing email as email header before the outgoing email is sent; and
including, by the email client, the outgoing time in the outgoing email when the outgoing email is sent, wherein the outgoing time is represented in UTC format and included in an email header of the outgoing email.

12. The system of claim 6, wherein
the email includes information with respect to sending time when the email is sent from a sender, the sending time represented in UTC format;
the outgoing email includes the incoming email serving as a forwarded email; and
the method further comprises:
including, by the email client, both the sending time in the UTC format and information concerning the time zone of the sender into the outgoing email, wherein the sending time is included in the outgoing email as email header before the outgoing email is sent; and
including, by the email client, the outgoing time in the outgoing email when the outgoing email is sent, wherein the outgoing time is represented in UTC format and included in an email header of the outgoing email.
